(19) United States
(12) Patent Application Publication
(10) Pub. No.: US 2012/0130885 A1
(43) Pub. Date: May 24, 2012

(54) UNIFIED PAYMENT ALLOCATION SYSTEM

(76) Inventor: JEFFREY K. FEIEREISEN, New York, NY (US)

(21) Appl. No.: 13/287,463

(22) Filed: Nov. 2, 2011

Related U.S. Application Data
(60) Provisional application No. 61/416,604, filed on Nov. 23, 2010.

(51) Int. Cl. G06Q 20/40; G06Q 40/02

(52) U.S. Cl. 705/38; 705/44

(57) ABSTRACT

In a method of making a financial transaction, a distinctive identification of a buyer is registered with an institution which assigns the identification of the buyer to data stored by the institution. A purchase by the buyer at a point of sale is approved by the institution, when the identification transmitted to the institution at the point of purchase and the data are verified by the institution. At a time after the institution has approved the purchase, the buyer selects the form of payment to be charged for the purchase, when the purchase is above a predefined minimum charge.

### CROSS-REFERENCES TO RELATED APPLICATIONS

This application claims the benefit of prior filed U.S. provisional Application No. 61/416,604, filed Nov. 23, 2010, pursuant to 35 U.S.C. 119(e), the content of which is incorporated herein by reference in its entirety as if fully set forth herein.

### BACKGROUND OF THE INVENTION

The present invention relates to a consumer-managed payment portal.

The following discussion of related art is provided to assist the reader in understanding the advantages of the invention, and is not to be construed as an admission that this related art is prior art to this invention.

Current methods of payment based on cash, credit, debit, or prepaid cards are tedious, cumbersome, and unsecure. Moreover, keeping cards or cash in pockets leaves them vulnerable to theft, loss, and potential identity fraud.

U.S. Pat. No. 7,604,166 discloses a method and system for flexible payments to enable buyers to pay for goods and services using only their fingerprints at the time and location of purchase. The method is based on buyers registering their fingerprints and one or more financial credit cards or bank accounts and relating one or more of their fingerprints to one or more convenient rules that will act on behalf of buyers at the time of purchase to select the appropriate payment method based on the following purchase conditions: purchase amount, purchase location and purchase time. Buyers can use their fingerprints to instantly pay for purchases where the payment system automatically matches the fingerprint at the time of purchase to registered fingerprints and uses the purchase amount, purchase location and purchase time to evaluate the conditional part of all registered convenient rules related to the matched fingerprint where the action part of one rule is used to select and further charge one or more of the previously registered payment methods.

It would be desirable and advantageous to address prior art shortcomings.

### SUMMARY OF THE INVENTION

According to one aspect of the present invention, a method of making a financial transaction includes registering a distinctive identification of a buyer with an institution, assigning the identification of the buyer to data stored by the institution, approving a purchase by the buyer at a point of sale by the institution, when the identification transmitted to the institution at the point of purchase and the data are verified by the institution, and instructing the institution by the buyer, after the institution has approved the purchase, about the form of payment to be selected for applying payment for the purchase, when the purchase is above a predefined minimum charge.

The present invention resolves prior art problems by providing a middle-man interface between the purchaser and a financial institution. Purchases can be made at any offline location, such as merchants, stores, or restaurants, as well as through any internet-enabled devices such as mobile phones or computers. A method according to the present invention is applicable to any process that transmits identification data, either through a wired connection or wirelessly, for the purposes of identification verification and payment. The purchaser has complete control as to the form of payment after the purchase has been made, without carrying the form of payment with him or her, by instructing the institution to apply at least one financial account to the purchase. This provides flexibility to assign a purchase to a financial account after the purchase has been initially made through the use of a temporary line of credit advanced by the financial institution.

According to another advantageous feature of the present invention, the identification can be a biometric input or any other personally identifiable medium. The biometric input may, e.g., involve fingerprint, fingerprint pattern, iris, and voice. For example, fingerprint representation data can be initially registered with an account through fingerprint reader scans or other available digitization options.

According to another advantageous feature of the present invention, the data can include one or more credit card accounts, one or more debit card accounts, one or more smart card accounts, one or more bank accounts, and any other personally identifiable account.

According to another advantageous feature of the present invention, the personally identifiable account can include a rewards account or a corporate membership program.

According to another advantageous feature of the present invention, the institution may involve a commercial bank, savings bank, lending institution, and any other company providing individually identifiable accounts.

According to another advantageous feature of the present invention, the instructing step can be executed within a predefined time interval negotiated between the institution and the buyer. Suitably, the predefined time interval is determined by executing a background evaluation of the buyer. The background evaluation may for example include credit score, credit limit, or account balances.

According to another advantageous feature of the present invention, the buyer can assign a default account from which funds are automatically drawn by the institution in the absence of an execution of the instructing step within the predefined time interval. In this situation, the institution may charge a fee or interest for the purchase.

According to another advantageous feature of the present invention, the minimum charge may be $0. As an alternative, the minimum charge may also be an amount above $0, wherein the institution can then automatically assign a form of payment to the purchase as selected by the buyer, when a payment amount is below the minimum charge. The predetermined minimum charge may be based on the type of purchase, e.g. groceries, gas, movies, etc.

According to another advantageous feature of the present invention, the form of payment may be split between different accounts.

According to another advantageous feature of the present invention, a payment method can be automatically applied to a purchase based on the type of purchase, as set forth by the purchaser in advance. This provides the flexibility for example to recognize food purchases at locations other than supermarkets or restaurants, such as theaters or stadiums.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a flow chart illustrating an exemplary registering process with an institution;

FIG. 2 is a flow chart illustrating an exemplary purchasing process; and

FIG. 3 is a flow chart illustrating the payment method assignment process.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

The following description relates by way of example to the use of a fingerprint as identification. It is, of course, within the scope of the present invention to use any other form of identification to execute the method according to the present invention.

In general, a method according to the present invention involves a buyer having his/her form of identification, e.g. a fingerprint, verified by an institution which is recognized by the merchant and in a position to authorize the purchase at a point of sale (POS). The verification can be realized on a buyer's computer or a computer at the checkout of the place of sale. When fingerprint identification is involved for example, fingerprint representation data (along with a required PIN if desired) is sent to the institution which cross-references the fingerprint data with its own database to verify that the buyer has an active account with funds available. If an account cannot be matched, the institution denies payment. If a match is found, but the buyer's account does not have sufficient funds, the institution can either deny payment or approve the purchase under its own temporary line of credit. If a match is found and the buyer's account has sufficient fund, the purchase is approved and payment is made by the institution. The buyer then has a predetermined time interval to assign the purchase to an account from which funds are then drawn by the institution. In the absence of instructions by the buyer, the institution can charge a fee or interest.

Although not described in detail, it is, of course, required to provide a relationship between the institution and the merchant to ensure payment of the purchase amount from the institution to the merchant. Any established verification processes are applicable here, e.g. the transaction process as established between the MasterCard network, financial institutions, and merchants.

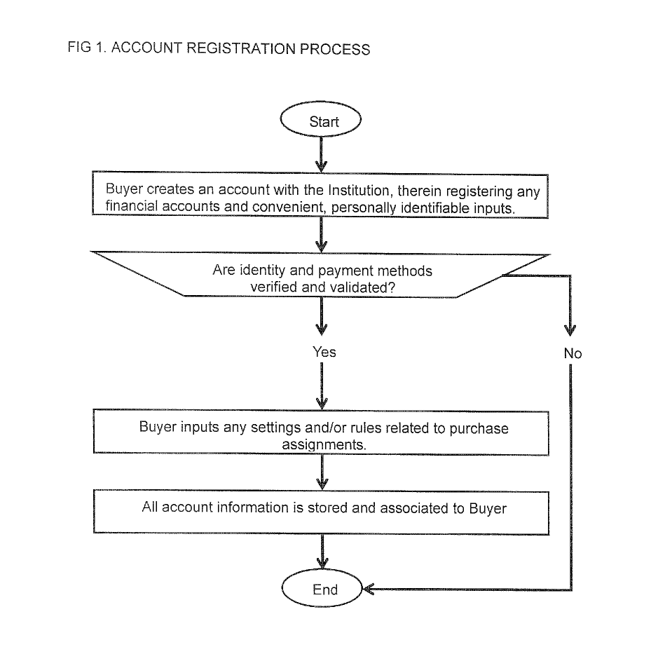

Turning now to the drawing, and in particular to FIG. 1, there is shown a flow chart illustrating an exemplary registering process with the institution.

A buyer or consumer opens an account with the institution, which could be any person or financial institution, such as commercial bank, savings bank, lending institution, or any other company providing individually identifiable accounts, using an email address or login name and password. After establishing an account, the registered buyer provides some form of identification as data to the institution, such as biometric input or any other personally identifiable medium, e.g. fingerprint, fingerprint pattern, iris, and voice and provides information about one or more financial accounts which may be held by a same financial institution or several different financial institutions. The account's login information can then be based on the form of identification, optionally in addition to a previously selected unique identifier. Identity and account information are verified by the Institution.

Once, the account is opened and required identifying data has been entered, the buyer enters additional information about the form of payment that the buyer wishes to use for reimbursing the institution for purchases. Normally the form of payment involves financial accounts with banks or other financial institutions and can include one or more credit card accounts, one or more debit card accounts, one or more smart card accounts, one or more bank accounts, and any other personally identifiable account. Of course, in order to provide the buyer the option to select a financial account from a plurality of financial accounts, at least two financial accounts have to be entered. Legitimacy of the entered data about the form of payment is validated by the institution and if affirmative the registration process is complete and the account is opened.

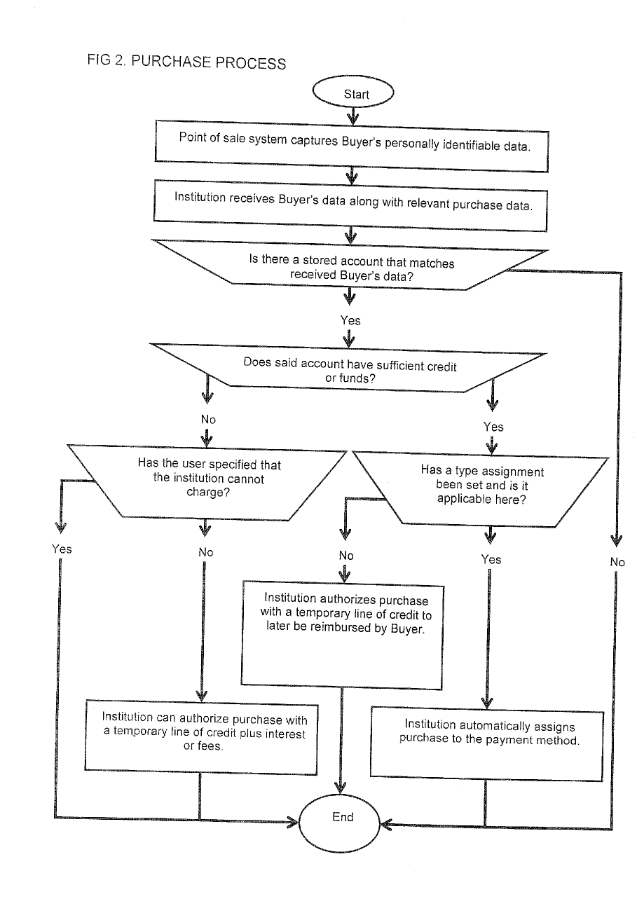

With reference to FIG. 2, the purchase process will now be described. At the point of sale, when the buyer is about to pay for the purchase, the merchant transmits the buyer's form of identification and any other relevant purchasing data including, but not limited to, purchase amount, location, date, etc. to the institution to initiate an authorization process. This form of identification may, for example, be fingerprint scanning as outlined in U.S. Pat. No. 7,604,166 to which reference is made herewith and the entire specification and drawings of which are expressly incorporated herein by reference. The institution cross-references its database to verify the existence of the buyer's account based on the transmitted form of identification, such as, e.g., fingerprint representation data. Various basic scenarios can then occur:
1) If no match is found, no authorization for the purchase is given.
2) If a match is found, but the funds in the associated financial accounts are insufficient, no authorization for the purchase is given.
3) If a match is found, and the associated financial accounts have adequate funds authorization for the purchase is given and the institution guarantees the payment to the merchant.

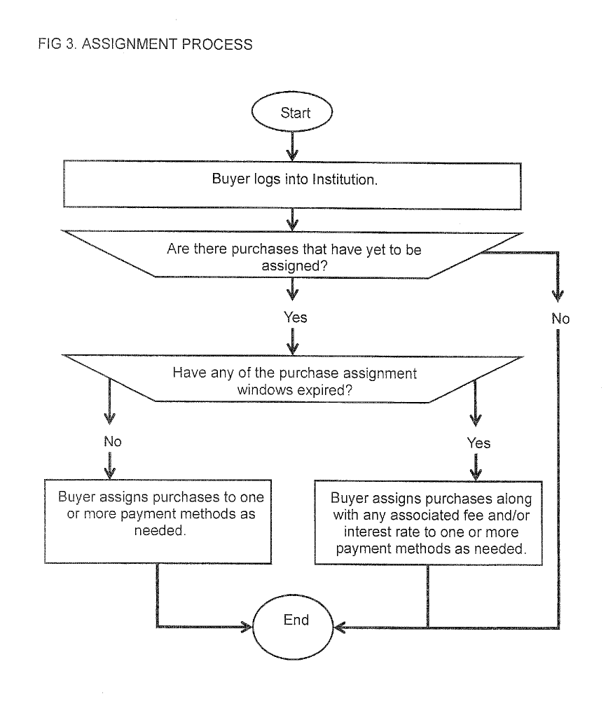

FIG. 3 illustrates the assignment process and the manner of reimbursing the institution. Within a predefined time interval, after authorization of the purchase has been given by the institution, the buyer has to select a financial account to reimburse the institution. The predefined time interval is negotiated between the institution and the buyer and depends on background evaluation of the buyer by the institution, such as credit score, credit limit, or account balances. The buyer logs into his account with the institution and checks for the purchase that needs to be balanced. The buyer selects one or more of the available financial accounts to have the proper funds transmitted to the institution.

This process according to the invention does not only provide the buyer the possibility to leave credit cards or debit cards at a safe place but also affords the buyer flexibility when making the actual payment for the purchase.

There are, of course, variations to the described process which will now be described. For example, when the institution finds a match but determines the funds in the associated buyer's financial accounts are insufficient, instead of declining authorization, the institution may still give authorization but charges interest or fees for the advanced monies. Also the institution may automatically draw funds from the buyer's financial accounts, when the buyer fails to instruct the institution within the predefined time interval about the selected account. Another variation involves purchases below a minimum amount negotiated between the buyer and the institution. In this case, the institution automatically assigns a form of payment to the purchase as selected by the buyer, when the payment amount is below the minimum charge.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a buyer skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of making a financial transaction, comprising:
registering a distinctive identification of a buyer with an institution;
assigning the identification of the buyer to data stored by the institution;
approving a purchase by the buyer at a point of sale by the institution, when the identification transmitted to the institution at the point of purchase and the data are verified by the institution; and
instructing the institution by the buyer, after the institution has approved the purchase, about the form of payment to be selected for applying payment for the purchase, when the purchase is above a predefined minimum charge.

2. The method of claim 1, wherein the identification is a biometric input or any other personally identifiable medium.

3. The method of claim 2, wherein the biometric input is a member selected from the group consisting of fingerprint, fingerprint pattern, iris, and voice.

4. The method of claim 1, wherein the instructing step includes assigning a payment account which is associated to the data and selected by the buyer as form of payment at a time after the purchase has been made.

5. The method of claim 1, wherein the data includes at least one member selected from the group consisting of one or more credit card accounts, one or more debit card accounts, one or more smart card accounts, one or more bank accounts, and any other personally identifiable account.

6. The method of claim 1, wherein the personally identifiable account includes a rewards account or a corporate membership program.

7. The method of claim 1, wherein the institution is a member selected from the group consisting of commercial bank, savings bank, lending institution, and any other company or persons providing individually identifiable accounts.

8. The method of claim 4, wherein the buyer assigns the payment account within a predefined time interval negotiated between the institution and the buyer.

9. The method of claim 8, wherein the predefined time interval is determined by executing a background evaluation of the buyer.

10. The method of claim 8, wherein the buyer assigns a default account from which funds are automatically drawn by the institution in the absence of an execution of the instructing step within the predefined time interval.

11. The method of claim 10, wherein the institution charges a fee or interest for the purchase in the absence of an execution of the instructing step within the predefined time interval.

12. The method of claim 9, wherein the background evaluation includes credit score, credit limit, or account balances.

13. The method of claim 1, wherein the minimum charge is $0.

14. The method of claim 1, wherein the minimum charge is an amount above $0, wherein the institution automatically assigns a form of payment to the purchase as selected by the buyer, when a payment amount is below the minimum charge.

15. The method of claim 1, wherein the predetermined minimum charge is based on the type of purchase.

16. The method of claim 4, wherein the form of payment is split between different members.

17. The method of claim 1, wherein the instruction is automatically set to employ a payment method for a specific purchase type.
